(19) United States
(12) Patent Application Publication
(10) Pub. No.: US 2019/0299970 A1
(43) Pub. Date: Oct. 3, 2019

(54) HYBRID VEHICLE

(71) Applicant: FORD GLOBAL TECHNOLOGIES, LLC, Dearborn, MI (US)

(72) Inventor: Eric Van Anrooy MONEY, San Jose, CA (US)

(21) Appl. No.: 15/938,853

(22) Filed: Mar. 28, 2018

(51) Int. Cl. B60W 20/10; B60K 6/52; B60K 7/00; B60K 6/48; B60W 10/192; B60W 10/08; B60W 10/119; B60W 20/30; B60W 30/18

(52) U.S. Cl. CPC B60W 20/10; B60K 6/52; B60K 7/0007; B60K 6/48; B60W 10/192; B60W 2540/12; B60W 10/119; B60W 20/30; B60W 30/18109; B60W 2540/10; B60W 10/08

(57) ABSTRACT

A vehicle includes an engine, frictions brakes, and a first electric machine. The engine is configured to deliver torque to first and second drive wheels along a first torque path. The friction brakes are configured to brake the first and second drive wheels along the first torque path. The first electric machine is configured to deliver torque to and brake a third drive wheel along a second torque path such that the third drive wheel is braked only by magnetic resistance generated by the first electric machine.

### TECHNICAL FIELD

The present disclosure relates to hybrid vehicles and powertrain configurations for hybrid vehicles.

### BACKGROUND

Hybrid vehicles may utilize multiple power sources, including internal combustion engines and electric machines, to generate power within a powertrain of the hybrid vehicle.

### SUMMARY

A vehicle includes an engine, frictions brakes, and a first electric machine. The engine is configured to deliver torque to first and second drive wheels along a first torque path. The friction brakes are configured to brake the first and second drive wheels along the first torque path. The first electric machine is configured to deliver torque to and brake a third drive wheel along a second torque path such that the third drive wheel is braked only by magnetic resistance generated by the first electric machine.

A vehicle includes a first torque path, a first friction brake, and a second torque path. The first torque path is configured to transfer torque from an engine to a first drive wheel. The first friction brake is configured to brake the first drive wheel along the first torque path. The second torque path is configured to deliver torque to and brake a second drive wheel via a first electric machine, wherein the second drive wheel is braked only by magnetic resistance generated by the first electric machine.

A vehicle includes an engine, friction brakes, a first motor/generator, and a second motor/generator. The engine is configured to deliver torque to first and second drive wheels. The friction brakes are configured to brake the first and second drive wheels. The first motor/generator is configured to deliver torque to and brake a third drive wheel. The second motor/generator is configured to deliver torque to and brake a fourth drive wheel. The third and fourth drive wheels are braked only by magnetic resistance generated by the first and second motor/generators, respectively.

### BRIEF DESCRIPTION OF THE DRAWINGS

FIG. 1 is a schematic illustration of a representative powertrain of a hybrid electric vehicle.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

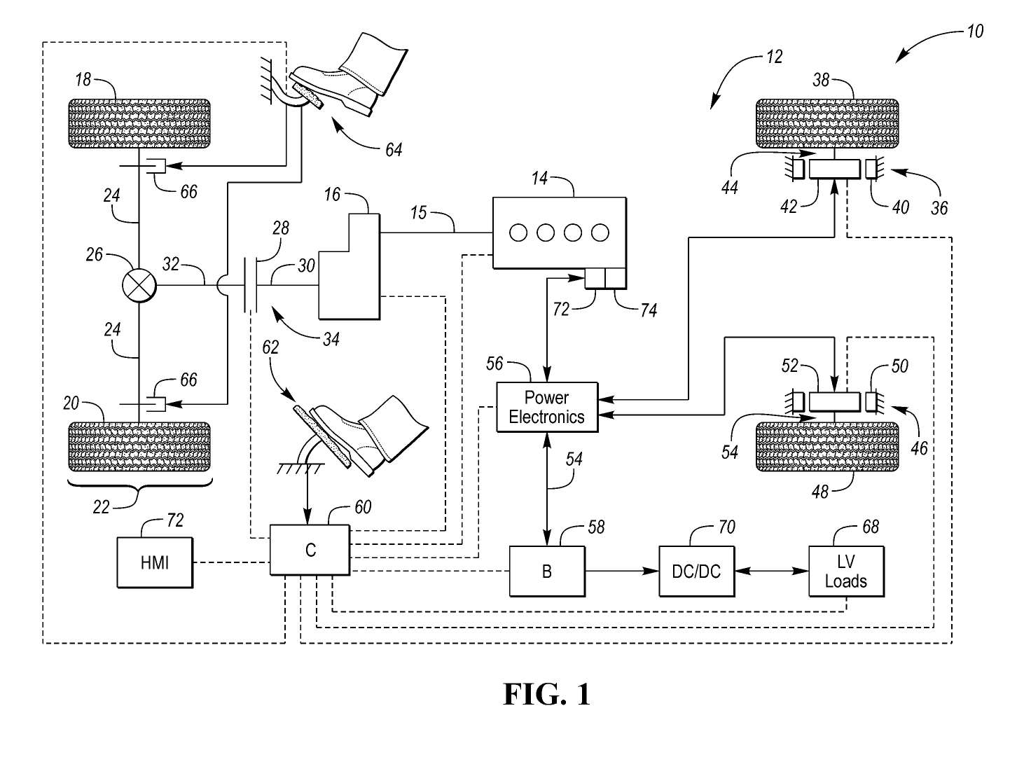

Referring to FIG. 1, a schematic diagram of a hybrid electric vehicle (HEV) 10 is illustrated. The HEV 10 may be referred to as a divorced-parallel hybrid vehicle that includes multiple power plants (e.g., internal combustion engines or electric motors) that deliver power to separate drive wheels. The HEV 10 includes a powertrain 12. The powertrain 12 includes an engine 14 that drives a transmission 16 via a crankshaft 15 to transfer torque and power from the engine 14 to a first drive wheel 18 and a second drive wheel 20. The transmission 16 may be placed in PRNDSL (park, reverse, neutral, drive, sport, low) via transmission range selector. The transmission may be a multiple step-ratio automatic transmission, a continuously variable transmission (CVT), or any other type transmission that provides multiple speed ratios between an input and an output of the transmission 16. A launch clutch (not shown) or a torque converter (not shown) may be disposed between the transmission 16 and the crankshaft 15. If a torque converter is included, the torque converter may include a bypass clutch.

The transmission 16 may be configured to transfer torque and power from the engine to the first drive wheel 18 and the second drive wheel 20 via an axle 22. The axle 22 may more specifically be a front axle of the HEV 10. The first drive wheel 18 and the second drive wheel 20 may more specifically be opposing wheels on the front axle. The axle 22 may include half shafts 24, a differential 26, and universal joints (not shown). The universal joints may be disposed between the haft shafts 24 and the differential 26, and between the half shafts and the first and second drive wheels 18, 20. A disconnect clutch 28 may be disposed between the axle 22 and the transmission 16. The disconnect clutch 28 is configured to connect and disconnect an output shaft 30 of the transmission 16 to and from an input shaft 32 to the axle 22. Additional universal joints may be disposed between the transmission 16 and the differential 26. The additional universal joints may be secured to the output shaft 30 of the transmission 16 and/or the input shaft 32 to the axle 22. The mechanical components that are configured to transfer power and torque from the engine 14 to the road surface below the first and second drive wheels 18, 20 may be referred to as the first torque path 34 of the HEV 10. The first torque path may include the crankshaft 15, the transmission 16, the output shaft 30, the disconnect clutch 28, the input shaft 32, the differential 26, the half shafts 24, the first drive wheel 18, the second drive wheel 20, and any other intermediate component (e.g., a universal joint) that transfers power and torque from the engine 14 to the road surface below first and second drive wheels, 18, 20.

The powertrain 12 includes a first electric machine (or first motor/generator) 36 that is configured to deliver power and torque to a third drive wheel 38. The first electric machine includes a first stator 40 and a first rotor 42. The stator 40 of the first electric machine 36 may be directly connected to a hub of the third drive wheel 38 in order to deliver power and torque to turn the third drive wheel 38. Alternatively, intermediate components, such as a shaft and universal joints may be disposed between the stator 40 of the first electric machine 36 and the hub of the third drive wheel 38. The mechanical components that are configured to transfer power and torque from the first electric machine 36 to the road surface below the third drive wheel 38 may be referred to as the second torque path 44 of the HEV 10. The second torque path 44 may include the stator 40 of the first electric machine 36, the third drive wheel 38, and any other intermediate component (e.g., a shaft or a universal joint) that transfers power and torque from the first electric machine 36 to the road surface below third drive wheel 38. The second torque path 44 is completely independent of and disconnected from the first torque path 34.

The powertrain 12 includes a second electric machine (or second motor/generator) 46 that is configured to deliver power and torque to a fourth drive wheel 48. The fourth drive wheel 48 and the third drive wheel 38 may be opposing rear wheels of the HEV 10. The second electric machine 46 includes a second stator 50 and a second rotor 52. The second stator 50 of the second electric machine 46 may be directly connected to a hub of the fourth drive wheel 48 in order to deliver power and torque to turn the fourth drive wheel 48. Alternatively, intermediate components, such as a shaft and universal joints may be disposed between the second stator 50 of the second electric machine 46 and the hub of the fourth drive wheel 48. The mechanical components that are configured to transfer power and torque from the second electric machine 46 to the road surface below the fourth drive wheel 48 may be referred to as the third torque path 54 of the HEV 10. The third torque path 54 may include the second stator 50 of the second electric machine 46, the fourth drive wheel 48, and any other intermediate component (e.g., a shaft or a universal joint) that transfers power and torque from the second electric machine 46 to the road surface below fourth drive wheel 48. The third torque path 54 is completely independent of and disconnected from the first torque path 34 and the second torque path 44.

The engine 14, the first electric machine 36, and the second electric machine 46 are drive sources for the HEV 10 that are configured to propel the HEV 10. The engine 14 generally represents a power source that may include an internal combustion engine such as a gasoline, diesel, or natural gas powered engine, or a fuel cell. The engine 14 generates an engine power and corresponding engine torque that is supplied to the first and second drive wheels 18, 20 when the disconnect clutch 28 is at least partially engaged. The first electric machine 36 and the second electric machine 46 may each be implemented by any one of a plurality of types of electric machines. For example, the first electric machine 36 and the second electric machine 46 may be permanent magnet synchronous motors. Power electronics 56 condition direct current (DC) power provided a traction battery 58 to the requirements of the first electric machine 36 and the second electric machine 46, as will be described below. For example, power electronics 56 may provide three phase alternating current (AC) to each of the first electric machine 36 and the second electric machine 46.

When the disconnect clutch 28 is at least partially engaged, power and torque flow from the engine 14 to first and second drive wheels 18, 20 is possible. For example, the disconnect clutch 28 may be engaged so that the engine 14 propels the HEV 10 by delivering power and torque to the first and second drive wheels 18, 20. The disconnect clutch 28 can also be disengaged to isolate the engine 14 and the transmission 16 from the first and second drive wheels 18, 20 while the first electric machine 36 and/or the second electric machine 36 are acting as the drive source(s) for the HEV 10. Isolating the engine 14 and the transmission 16 from the first and second drive wheels 18, 20 while the HEV 10 is being propelled by at least one of the electric machines reduces parasitic losses and increases the range of an electric only mode where only the electric machine(s) are propelling the HEV.

The transmission 16, if not a CVT, may include gear sets (not shown) that are selectively placed in different gear ratios by selective engagement of friction elements such as clutches and brakes (not shown) to establish the desired multiple discrete or step drive ratios. The friction elements are controllable through a shift schedule that connects and disconnects certain elements of the gear sets to control the ratio between the output shaft 30 and input shaft to the transmission 16. The transmission 16 is automatically shifted from one ratio to another based on various vehicle and ambient operating conditions by an associated controller, such as a powertrain control unit (PCU). Power and torque from the engine 14 may be delivered to and received by transmission 16. The transmission 16 then provides power and torque to output shaft 30.

It should be understood that a hydraulically controlled transmission 16 used with a torque converter is but one example of a gearbox or transmission arrangement; any multiple ratio gearbox that accepts input torque(s) and then provides torque to an output shaft at the different ratios is acceptable for use with embodiments of the present disclosure. For example, transmission 16 may be implemented by an automated mechanical (or manual) transmission (AMT) that includes one or more servo motors to translate/rotate shift forks along a shift rail to select a desired gear ratio. As generally understood by those of ordinary skill in the art, an AMT may be used in applications with higher torque requirements, for example.

As shown in the representative embodiment of FIG. 1, the output shaft 30 is connected to the differential 26 via the disconnect clutch 28 and input shaft 32. The differential 26 drives the first and second drive wheels 18, 20 via respective axle 22 connected to the differential 26. The differential 26 transmits approximately equal torque to each of the first and second drive wheels 18, 20 while permitting slight speed differences such as when the vehicle turns a corner. Different types of differentials or similar devices may be used to distribute torque from the powertrain to one or more wheels. In some applications, torque distribution may vary depending on the particular operating mode or condition, for example.

The powertrain 12 further includes an associated controller 60 such as a powertrain control unit (PCU). While illustrated as one controller, the controller 60 may be part of a larger control system and may be controlled by various other controllers throughout the vehicle 10, such as a vehicle system controller (VSC). It should therefore be understood that the powertrain control unit 60 and one or more other controllers can collectively be referred to as a “controller” that controls various actuators in response to signals from various sensors to control functions such as starting/stopping engine 14, operating the first electric machine 36 and/or the second electric machine 46 to provide wheel torque or charge battery 58, select or schedule transmission shifts, etc. Controller 60 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The controller communicates with various engine/vehicle sensors and actuators via an input/output (I/O) interface (including input and output channels) that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. As generally illustrated in the representative embodiment of FIG. 1, controller 60 may communicate signals to and/or from engine 14, disconnect clutch 28 (via torque and/or speed sensors), first electric machine 36, second electric machine 46, battery 58, transmission 16, and power electronics 56. Although not explicitly illustrated, those of ordinary skill in the art will recognize various functions or components that may be controlled by controller 60 within each of the subsystems identified above. Representative examples of parameters, systems, and/or components that may be directly or indirectly actuated using control logic and/or algorithms executed by the controller include fuel injection timing, rate, and duration, throttle valve position, spark plug ignition timing (for spark-ignition engines), intake/exhaust valve timing and duration, front-end accessory drive (FEAD) components such as an alternator, air conditioning compressor, battery charging or discharging (including determining the maximum charge and discharge power limits), regenerative braking, first and/or second electric machine operation, clutch pressures for disconnect clutch 28, and transmission 16, and the like. Sensors communicating input through the I/O interface may be used to indicate turbocharger boost pressure, crankshaft position (PIP), engine rotational speed (RPM), wheel speeds (WS1, WS2, WS3, WS4), vehicle speed (VSS), coolant temperature (ECT), intake manifold pressure (MAP), accelerator pedal position (PPS), ignition switch position (IGN), throttle valve position (TP), air temperature (TMP), exhaust gas oxygen (EGO) or other exhaust gas component concentration or presence, intake air flow (MAF), transmission gear, ratio, or mode, transmission oil temperature (TOT), transmission turbine speed (TS), torque converter bypass clutch status (TCC), deceleration or shift mode (MDE), battery temperature, voltage, current, or state of charge (SOC) for example.

Control logic or functions performed by controller 60 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle, engine, and/or powertrain controller, such as controller 60. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

An accelerator pedal 62 is used by the driver of the vehicle to provide a demanded torque, power, or drive command to the powertrain 12 (or more specifically the engine 14, first electric machine 36, and/or second electric machine 46) to propel the vehicle. In general, depressing and releasing the accelerator pedal 62 generates an accelerator pedal position signal that may be interpreted by the controller 60 as a demand for increased power or torque, or decreased power or torque, respectively. A brake pedal 64 is also used by the driver of the vehicle to provide a demanded braking torque to slow the vehicle. In general, depressing and releasing the brake pedal 64 generates a brake pedal position signal that may be interpreted by the controller 60 as a demand to decrease the vehicle speed. Based upon inputs from the accelerator pedal 62 and brake pedal 64, the controller 60 commands the torque and/or power to the engine 14, the electric machine 36, the second electric machine 46, and a pair of friction brakes 66.

The pair of friction brakes 66 are disposed along the first torque path 34. The pair of friction brakes 66 are configured to only brake the first and second drive wheels 18, 20 along the first torque path 34. The third and fourth 38, 48 drive wheels do not include friction brakes. A first of the pair of friction brakes 66 may be configured to brake the first drive wheel 18 while the other of the pair of friction brakes 66 is configured to brake the second drive wheel 20. The pair of friction brakes 66 may be disk type friction brakes that include pads that engage a rotating disk or drum type friction brakes that include shoes that engage a rotating drum. The disk type or drum type friction brakes may be mechanical, pneumatically, hydraulically, or electrically operated and may be activated by an actuator such as a hydraulic cylinder (e.g., a master cylinder), a pneumatic cylinder, electric motor, or electric solenoid.

The first electric machine 36 is configured to brake the third drive wheel 38 along the second torque path 44 alone. The first electric machine 36 brakes the third drive wheel 38 by operating in a “generator mode” that creates a resistance to the motion of the third drive wheel 38. More specifically, the first electric machine 36 may generate a magnetic or electromagnetic resistance when operating in the “generator mode” to brake the third drive wheel 38.

The second electric machine 46 is configured to brake the fourth drive wheel 48 along the third torque path 54 alone. The second electric machine 46 brakes the fourth drive wheel 48 also by operating in a “generator mode” that creates a resistance to the motion of the fourth drive wheel 48. More specifically, the second electric machine 46 may generate a magnetic or electromagnetic resistance when operating in the “generator mode” to brake the fourth drive wheel 48.

The first electric machine 36 and/or the second electric machine 46 may each charge the battery 58 while braking the third and fourth drive wheels 38, 48, respectively. In the event that the battery 58 is charged and braking is required at the third and/or fourth drive wheels 38, 48, the electrical energy generated by braking may be diverted to a resistive element, such as a filament, that absorbs or converts the kinetic energy from braking into thermal energy. There are no friction brakes disposed along either the second torque path 44 or the third torque path 54 to brake the third or fourth drive wheels 38, 48, respectively. By eliminating the friction brakes on one set of wheels (whether they be the front or rear set of wheels) and mounting an electric machine directly to each of the set of wheels (which eliminates the need for intermediate components such as shafts or universal joints between wheels and the electric machines), the weight of the vehicle is reduced and fuel economy increased.

To drive the vehicle with the engine 14, the disconnect clutch 28 is at least partially engaged to transfer at least a portion of the engine torque from the transmission 16, through the disconnect clutch 28, through the axle 22 and to the first and second drive wheels 18, 20. The engine 14 may be operating alone (i.e., the engine is delivering power and torque to at least one drive wheel while the first and second electric machines are not deliver power and torque to at least one drive wheel) in an “engine only” mode. The first electric machine 36 and/or the second electric machine 46 may provide power and torque to the third drive wheel 38 and/or the fourth drive wheel 48, respectively, while the engine 14 provides power and torque to the first and second drive wheels 18, 20. This operation mode may be referred to as a “hybrid mode” or an “electric assist mode.”

To drive the vehicle with the first electric machine 36 and/or the second electric machine 46 as the only power source(s), the disconnect clutch 28 may isolate the engine 14 from the remainder of the powertrain 12. The combustion in the engine 14 may be disabled or otherwise OFF during this time to conserve fuel. Opening the disconnect clutch 28 also reduces parasitic losses by disconnecting the rotating components between the engine 14 and the disconnect clutch 28 from the first and second drive wheels 18, 20 when the rotating components are not being used to deliver power and torque to the first and second drive wheels 18, 20. The traction battery 58 transmits stored electrical energy through wiring 54 to the power electronics 56 that may include an inverter, for example. The power electronics 56 convert DC voltage from the battery 58 into AC voltage to be used by the first electric machine 36 and/or the second electric machine 46. The controller 60 commands the power electronics 56 to convert voltage from the battery 58 to an AC voltage provided to the first electric machine 36 and/or the second electric machine 46 to provide positive or negative torque to the shaft to the third drive wheel 38 and or fourth drive wheel 48, respectively. This operation mode may be referred to as an “electric only” or “EV” operation mode.

The first electric machine 36 and the second electric machine 46 may act as motors and provide driving forces to the third drive wheel 38 and fourth drive wheel 48, respectively. Alternatively, the first electric machine 36 and the second electric machine 46 may act as generators and convert kinetic energy of the vehicle into electric energy to be stored in the battery 58. The first electric machine 36 and the second electric machine 46 may act as generators while the engine 14 is providing propulsion power for the vehicle 10, for example. The first electric machine 36 and the second electric machine 46 may additionally act as generators during times of regenerative braking in which torque and rotational energy and power from the spinning third drive wheel 38 and from the spinning fourth drive wheel 48 is transferred back to the first electric machine 36 and second electric machine, respectively, and is converted into electrical energy for storage in the battery 58.

The battery 58 may be configured to provide electrical power to one or more low voltage loads 68 (e.g., vehicle accessories) via a DC/DC converter 70. The low voltage loads 68 may include, but are not limited to, heating, ventilating, and air conditioning (HVAC) systems, power steering systems, electric heaters, sensors used for collision avoidance or parking (e.g., lidar or ultrasound sensors), sound systems, radios, entertainment systems, or any other system or device that is electrically operated.

The battery 58 may also be configured to provide electrical power to other vehicle systems via an inverter of the power electronics 56. For example, the battery 58 may provide electrical power, via an inverter of the power electronics 56, to an electrical turbo charger 72, an electrical actuator of a pneumatic engine starter 74, or electrical actuators for intake and exhaust valves of the engine 14.

The HEV 10 may also include a human machine interface (HMI) 76. The HMI 76 may include an ignition switch, a control panel, a touchscreen, a paddle shifter located on a steering wheel, or any other device capable of receiving and input from an operator of the HEV 10. The HMI 76 may be configured to communicate with the controller 60, which in turn may adjust operating parameters of the various subsystem of the HEV 10 based on the operation of the HMI 76.

It should be understood that the designations of first, second, third, fourth, etc. for drive wheels, electric machines, torque paths, or any other component or system described with respect to FIG. 1 may be rearranged in the claims so that they are in chronological order with respect to the claims.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

1. A vehicle comprising:
an engine configured to deliver torque to first and second drive wheels along a first torque path;
friction brakes configured to brake the first and second drive wheels along the first torque path; and
a first electric machine configured to deliver torque to and brake a third drive wheel along a second torque path such that the third drive wheel is braked only by magnetic resistance generated by the first electric machine.

2. The vehicle of claim 1, wherein the second torque path is disconnected from the first torque path.

3. The vehicle of claim 1 further comprising a second electric machine configured to deliver torque to and brake a fourth drive wheel along a third torque path such that the fourth drive wheel is braked only by magnetic resistance generated by the second electric machine.

4. The vehicle of claim 3, wherein the third torque path is independent from the second torque path.

5. The vehicle of claim 3, wherein the third and fourth drive wheels are opposing rear wheels of the vehicle.

6. The vehicle of claim 1 further comprising a front axle, and wherein the first and second drive wheels are opposing wheels on the front axle.

7. The vehicle of claim 6 further comprising a disconnect clutch disposed between the front axle and the engine.

8. (canceled)

8. A vehicle comprising:
a first torque path configured to transfer torque from an engine to a first drive wheel;
a first friction brake configured to brake the first drive wheel along the first torque path;
a second torque path configured to deliver torque to and brake a second drive wheel via a first electric machine, wherein the second drive wheel is braked only by magnetic resistance generated by the first electric machine.

9. The vehicle of claim 8, wherein the second torque path is independent from the first torque path.

10. The vehicle of claim 8 further comprising a third torque path configured to deliver torque to and brake a third drive wheel via a second electric machine, wherein the third drive wheel is braked only by magnetic resistance generated by the second electric machine.

11. The vehicle of claim 10, wherein the third torque path is independent from the second torque path.

12. The vehicle of claim 10, wherein the second and third drive wheels are opposing rear wheels of the vehicle.

13. The vehicle of claim 8, wherein the first torque path is configured to transfer torque from the engine to a fourth drive wheel.

14. The vehicle of claim 13, wherein the first torque path includes a front axle, and wherein the first and fourth drive wheels are opposing wheels on the front axle.

15. The vehicle of claim 14, wherein the first torque path includes a disconnect clutch disposed between the front axle and the engine.

16. A vehicle comprising:
an engine configured to deliver torque to first and second drive wheels;
friction brakes configured to brake the first and second wheels;
a first motor/generator configured to deliver torque to and brake a third drive wheel; and
a second motor/generator configured to deliver torque to and brake a fourth drive wheel, wherein the third and fourth drive wheels are braked only by magnetic resistance generated by the first and second motor/generators, respectively.

17. The vehicle of claim 16, wherein the third and fourth drive wheels are opposing rear wheels of the vehicle.

18. The vehicle of claim 16 further comprising a front axle, and wherein the first and second drive wheels are opposing wheels on the front axle

19. The vehicle of claim 18 further comprising a disconnect clutch disposed between the front axle and the engine.

20. The vehicle of claim 19 further comprising a multi-ratio transmission disposed between the disconnect clutch and the engine.
